(19) United States
(12) Patent Application Publication
(10) Pub. No.: US 2018/0249886 A1
(43) Pub. Date: Sep. 6, 2018

(54) WASHABLE KNIFE BLOCK ASSEMBLY

(71) Applicant: THE SCOTT FETZER COMPANY, Walnut Ridge, AR (US)

(72) Inventors: TED THOMPSON, Walnut Ridge, AR (US); Tim Wiener, Jonesboro, AR (US); Dustin Smith, Walnut Ridge, AR (US)

(21) Appl. No.: 15/911,751

(22) Filed: Mar. 5, 2018

Related U.S. Application Data
(63) Continuation of application No. 29/596,001, filed on Mar. 3, 2017.
(60) Provisional application No. 62/466,664, filed on Mar. 3, 2017.

(51) Int. Cl. A47L 19/02; A47G 21/14

(52) U.S. Cl. CPC A47L 19/02; B29C 69/00; A47G 21/14

(57) ABSTRACT

A washable utensil storage assembly and method of constructing the assembly includes a body comprising a plurality of walls and at least one shelf for locating a holding assembly for supporting utensils. The body further comprises a cavity formed by the plurality of walls that is enclosed by the at least one shelf at a first end and a removably positioned panel at a second end spaced from the first end.

### CROSS REFERENCES TO RELATED APPLICATIONS

The following application claims priority under 35 U.S.C. § 119(e) to co-pending U.S. Provisional Patent Application Ser. No. 62/466,864 filed Mar. 3, 2017 entitled WASHABLE KNIFE BLOCK ASSEMBLY and priority under 35 U.S.C. § 120 to co-pending U.S. Design patent application Ser. No. 29/596,001 filed Mar. 3, 2017 entitled WASHABLE KNIFE BLOCK. The above-identified applications are incorporated herein by reference in their entireties for all purposes.

### TECHNICAL FIELD

The present disclosure relates to a washable utensil or knife block assembly, and more particularly, a knife block assembly for storing utensils. The washable knife block assembly can be repeatedly cleaned in a conventional dishwasher.

### BACKGROUND

Conventional knife blocks are designed from wood and used to store a number of different utensils, including, but not limited to, steak knives, paring knives, cleavers, scissors, honing rods, chef knives, tomato slicers, bread knives, fillet knives, utility knives, santoku knives, and the like. Such knife blocks are typically located on a counter in a residential or commercial kitchen, making it convenient for a chef or cook to access the desired cutlery.

Because conventional knife blocks are formed from solid blocks of wood, cleaning the blocks in a dishwasher would make it hard for the blocks to properly dry, likely weaken or destroy the wood after repeated cycles, and typically produce a build-up of mildew. Such exposure to the harsh conditions within a dishwasher may further cause the wood to splinter.

### SUMMARY

One aspect of the present disclosure includes a washable utensil storage assembly and method of constructing the assembly. The assembly includes a body comprising a plurality of walls and at least one shelf for locating a holding assembly for supporting utensils. The body further comprises a cavity formed by the plurality of walls that is enclosed by the at least one shelf at a first end and a removably positioned panel at a second end spaced from the first end.

Another aspect of the present disclosure includes a method of assembling a washable utensil storage assembly. The method comprising the steps of molding a body having at least four sides and first and second shelf platforms from a first mold; molding a first shelf holding assembly from a second mold; molding a second shelf holding assembly from a third mold; molding a selectively removable panel from a fourth mold; and assembling the first shelf holding assembly, the second shelf holding assembly and selectively removable panel to the body.

While another aspect of the present disclosure comprises washable knife block. The washable knife block comprises a body having a plurality of walls that forms a cavity within the walls, first and second shelves located at a first end of the body, and a selectively removable panel located at a second end of the body, the walls spacing the first end from the second end. The first and second shelves have respective first and second support members, each support member providing a holding assembly for storing utensils. The holding assembly has a plurality of channels; the channels comprise a first opening located on the surface of the shelves and a second opening spaced by a channel body from the first opening, the second opening extending into the cavity. The washable knife block also comprises a plurality of vent openings asymmetrically located on the selectively removable panel.

### BRIEF DESCRIPTION OF THE DRAWINGS

The foregoing and other features and advantages of the present disclosure will become apparent to one skilled in the art to which the present invention relates upon consideration of the following description of the invention with reference to the accompanying drawings, wherein like reference numerals refer to like parts unless described otherwise throughout the drawings and in which:

FIG. 1 is an upper front perspective view of a washable knife block assembly illustrated in accordance with one example embodiment of the present disclosure;

FIG. 2 is an upper rear perspective view thereof;

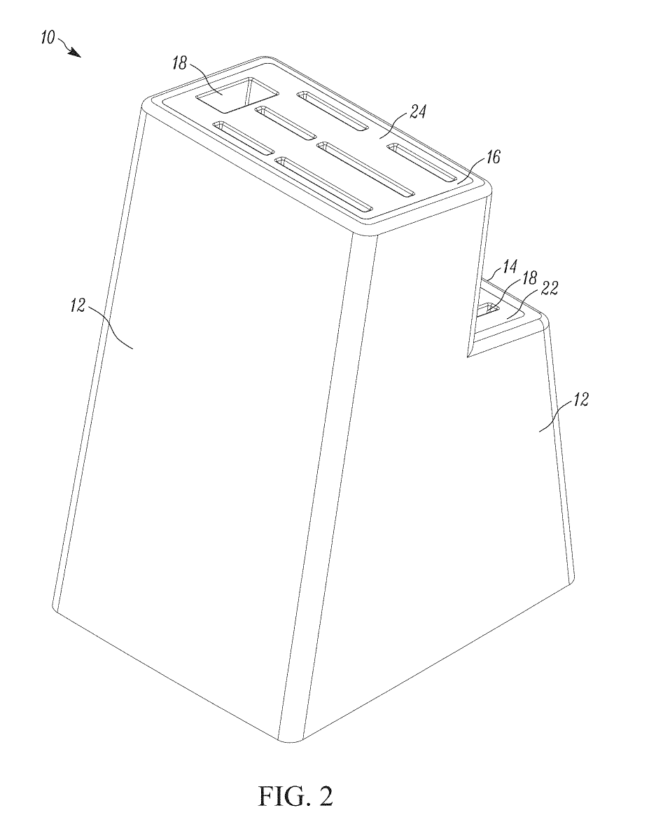

FIG. 3 is a lower rear perspective view thereof;

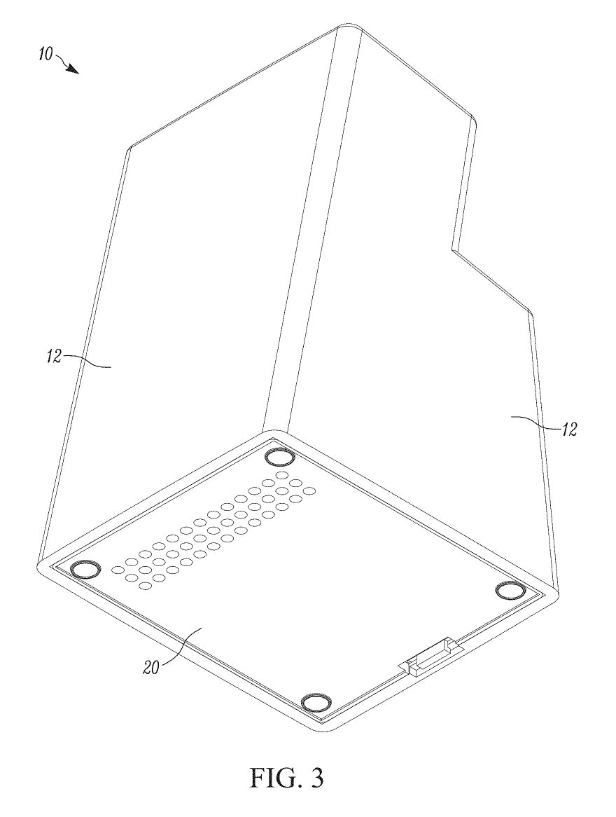

FIG. 4 is a lower front perspective view thereof;

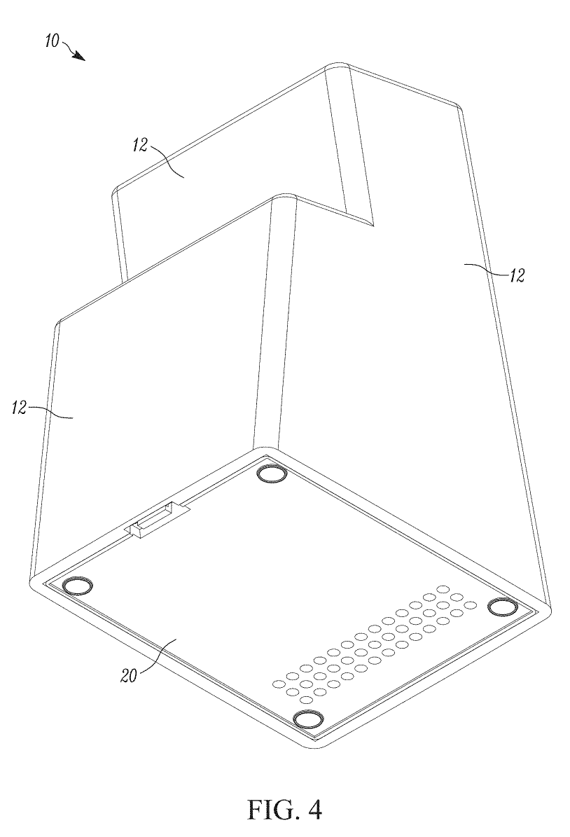

FIG. 5 is a right side elevation view thereof;

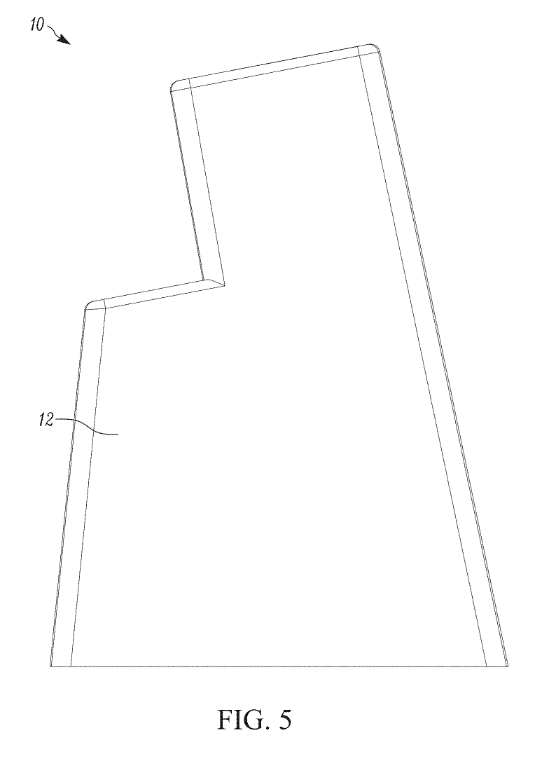

FIG. 6 is a left side elevation view thereof;

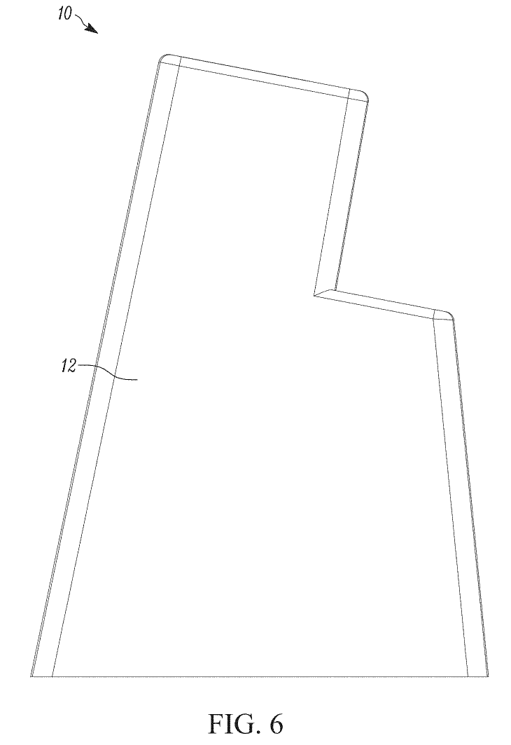

FIG. 7 is a front elevation view thereof;

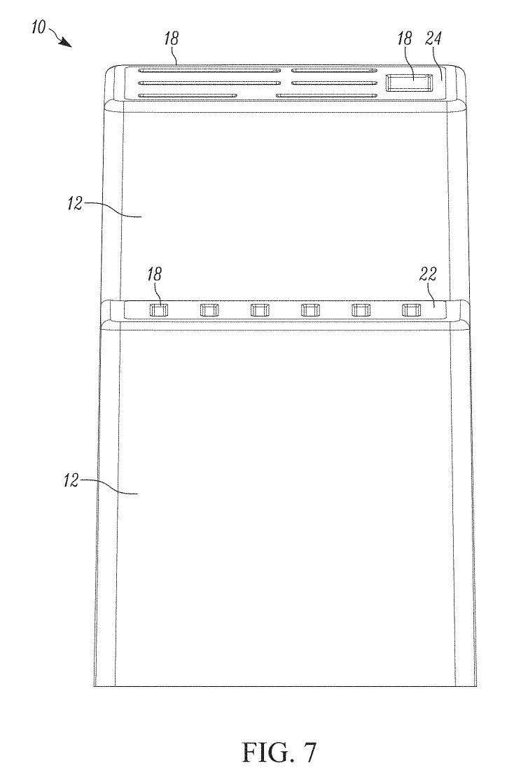

FIG. 8 is a rear elevation view thereof;

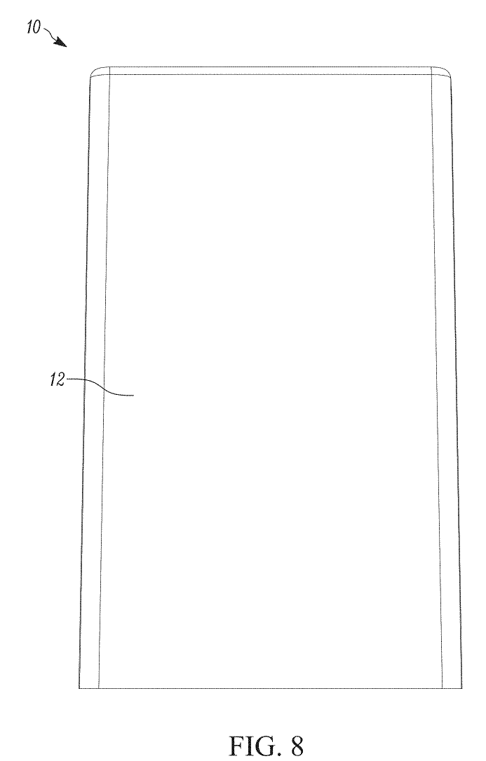

FIG. 9 is a top plan view thereof;

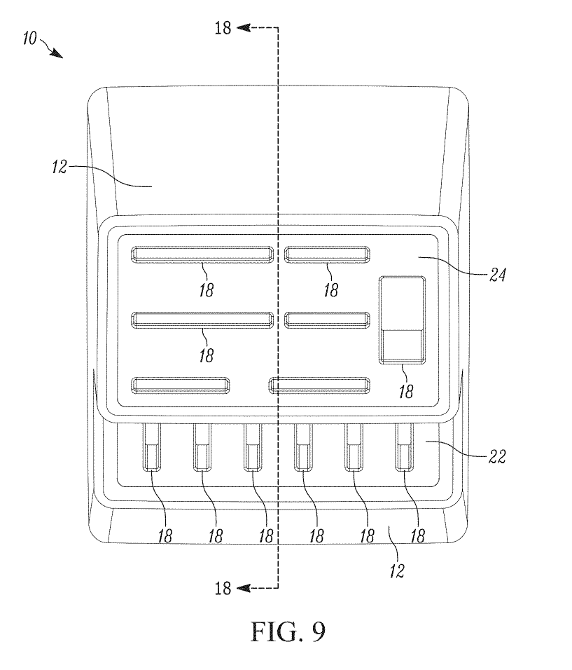

FIG. 10 is a bottom plan view thereof;

FIG. 11 is an upper exploded assembly view thereof;

FIG. 12 is a lower exploded assembly view thereof;

FIG. 13 is a front elevation section view of a first component of the washable knife block assembly along section lines 13-13 of FIG. 11 thereof;

FIG. 14 is a side elevation section view of a second component of the washable knife block assembly along section lines 14-14 of FIG. 11 thereof;

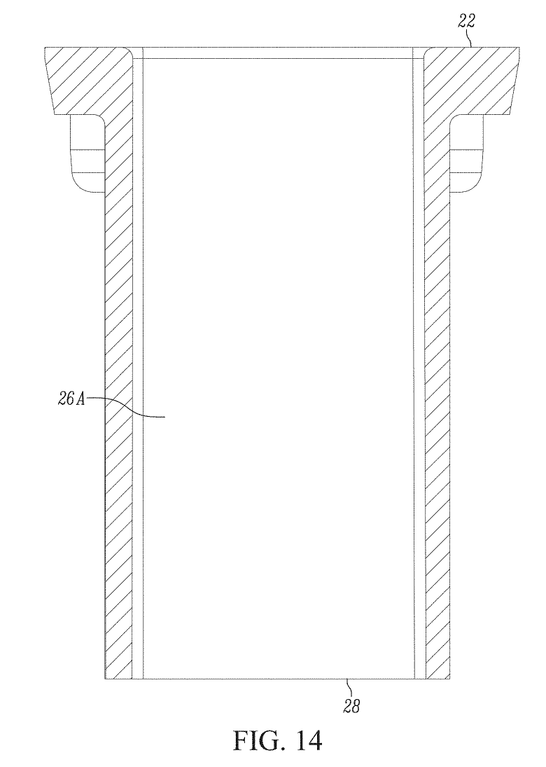

FIG. 15 is a front elevation section view of a first body portion of the washable knife block assembly along section lines 15-15 of FIG. 11 thereof;

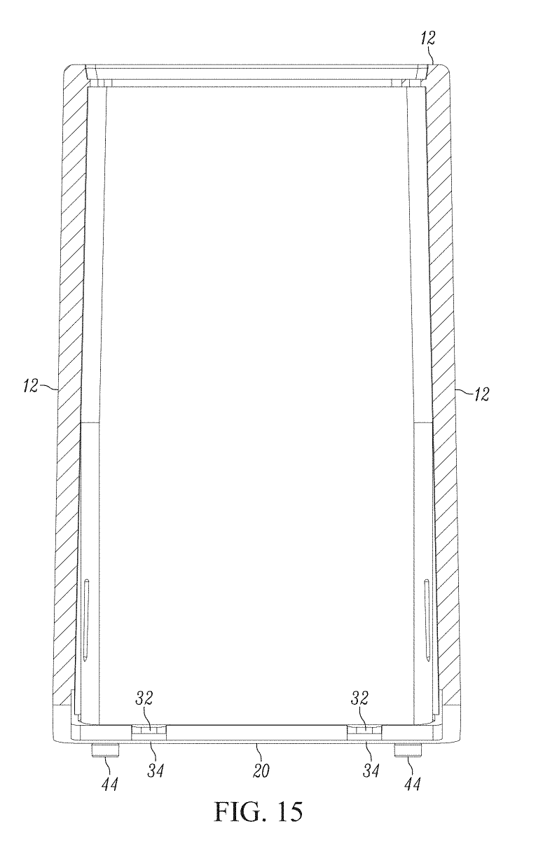

FIG. 16 is a front elevation section view of a second body portion of the washable knife block assembly along section lines 16-16 of FIG. 11 thereof;

FIG. 17 is a front elevation section view of a panel cover of the washable knife block assembly along section lines 17-17 of FIG. 11 thereof; and

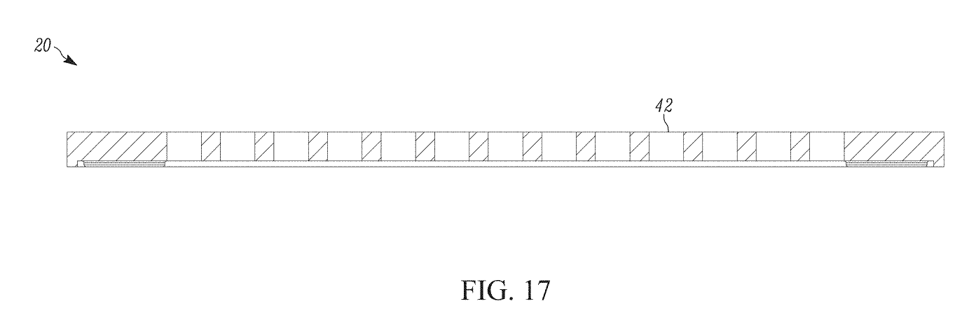

FIG. 18 is a side elevation section view of the washable knife block assembly along section lines 18-18 of FIG. 9 thereof.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements throughout unless otherwise noted. The present disclosure relates to a washable utensil or knife block assembly, and more particularly, a knife block assembly for storing utensils. The washable knife block assembly can be repeatedly cleaned in a conventional dishwasher.

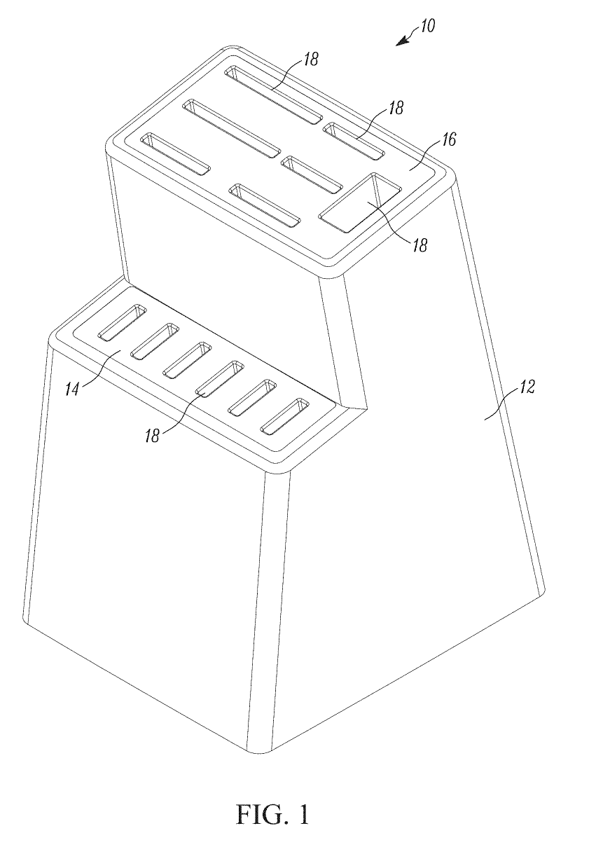

Illustrated in FIG. 1 is an upper front perspective view of a washable utensil or knife block assembly 10 constructed in accordance with one example embodiment of the present disclosure. The knife block assembly 10 comprises a body 12 having a lower storage shelf 14 and an upper storage shelf 16. Both shelves comprise a number of openings 18 of varying sizes for supporting different sized utensils. For example, the openings could support the following utensils, comprising, but not limited to, steak knives, paring knives, cleavers, scissors, honing rods, chef knives, tomato slicers, bread knives, fillet knives, utility knives, santoku knives, spoons, forks, whisks, and the like (hereinafter individually “utensil” and plural “utensils”).

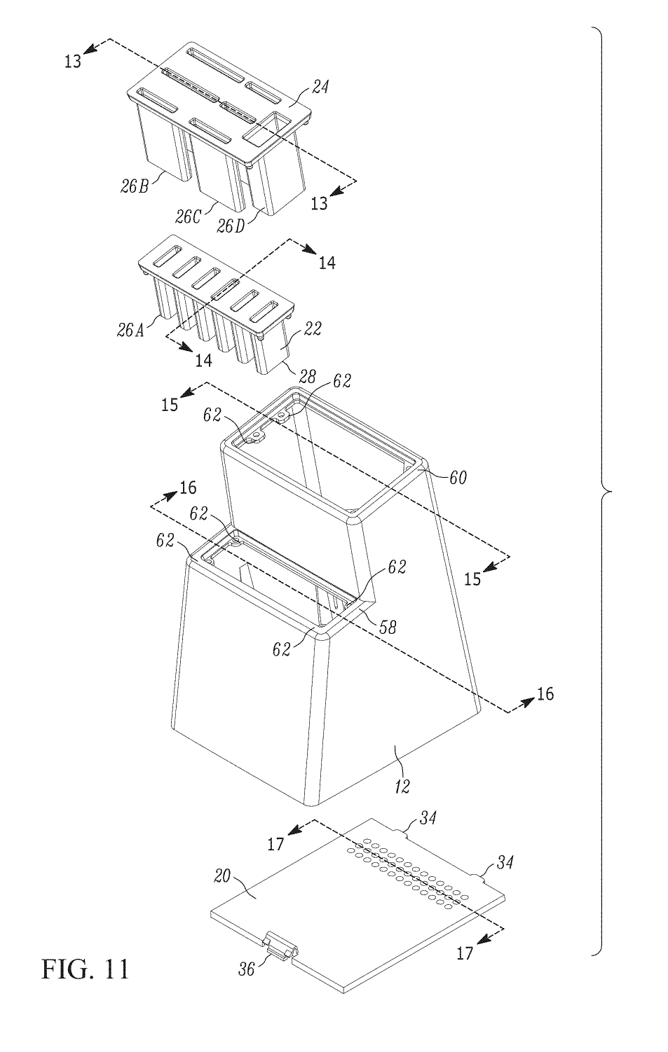

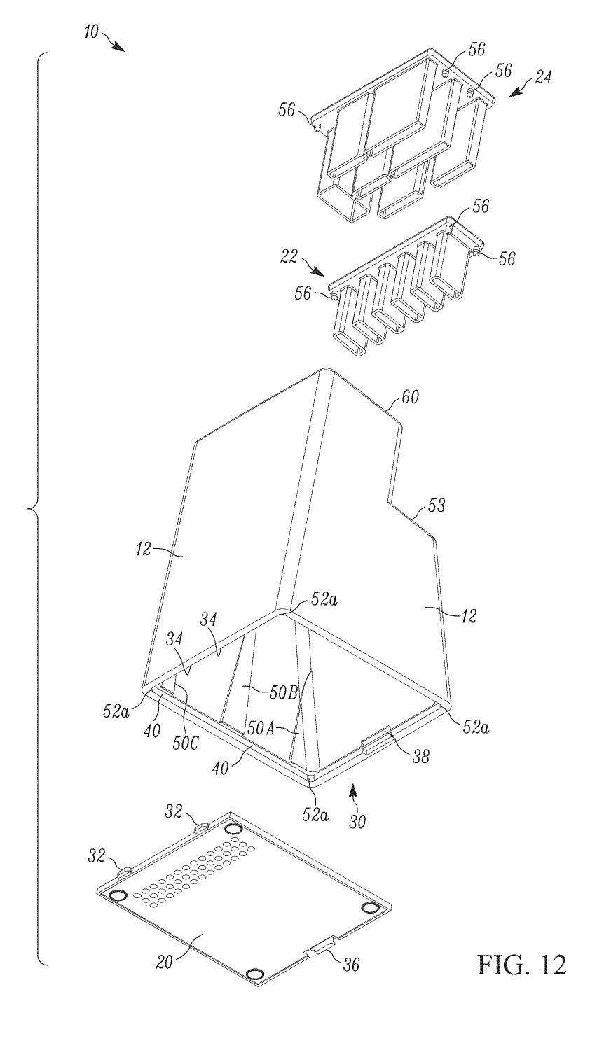

In the illustrated example embodiment, the knife block assembly 10 is a molded polymer. Such polymers include, but are not limited to, ABS, polyethylene, polypropylene, polystyrene, rubber, plastic resin, wood composite or any combination thereof. In another example embodiment, the molded polymer comprises an antimicrobial material or is blended with an antimicrobial material such as MicroBan, CIBA, and the like. In another example embodiment, the block assembly 10 is formed of a molded polymer from four separately plastic mold injected components, as illustrated in FIGS. 11 and 12.

The four components individually molded forming the knife block assembly 10 include, a base plate 20, body 12, lower holding assembly 22, and upper holding assembly 24. In yet another example embodiment, the knife block assembly 10 is formed from a polymer while the portions contacting and supporting the utensils (lower and upper holding assemblies, 22 and 24, respectively) comprise an anti-microbial material or are blended with an anti-microbial material and polymer. While in yet another example embodiment, each of the four components, 20, 12, 22, and 24 are formed from a polymer of the same or differing pigments. This is advantageous, for example, when it is desirable for the owner to have the holding assemblies match the color of the utensil handles.

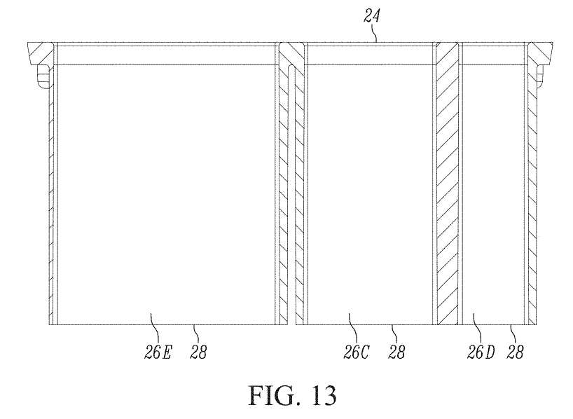

While the lower holding assembly includes six utensil-holding openings 18 and the upper holding assembly includes seven holding openings 18, any number or combination of openings for the different utensils can be used. Each opening 18 includes a guide channel 26 (see FIG. 11). The guide channels 26A are shown to support steak knives, 26B and 26C to support bread, chef, fillet, utility, and/or santoku knives, 26D to support scissors or shears, or honing rods, and 26E (see FIG. 13) supports a cleaver knife.

In the illustrated example embodiment, the steak knife opening 18 is approximately 0.75″ (inches) (lateral extent) by 0.16″ (inches) (thickness opening) and guide channels 26A are approximately 1.5″ (inches) in length (longitudinal extent) from the surface of the holding assembly 24 to the inner block opening 28. While in the illustrated example embodiment, the length or longitudinal extent of the guide channels 26B, 26C, 26D, and 26E are approximately 2.175″ (inches) in length from the holding assembly to the inner block opening 28. The opening 18 for guide channel 26D, typically used to support shears or scissors in the illustrated example embodiment, 1.63″ (inches) (lateral extent) by 0.57″ (inches) (width opening). The remaining slot openings 18 (lateral extents) in the upper holding assembly are varying lengths from 1″ (inch) to 4″ (inches) by 0.16″ (inches) (width opening) for supporting varying sizes of knives.

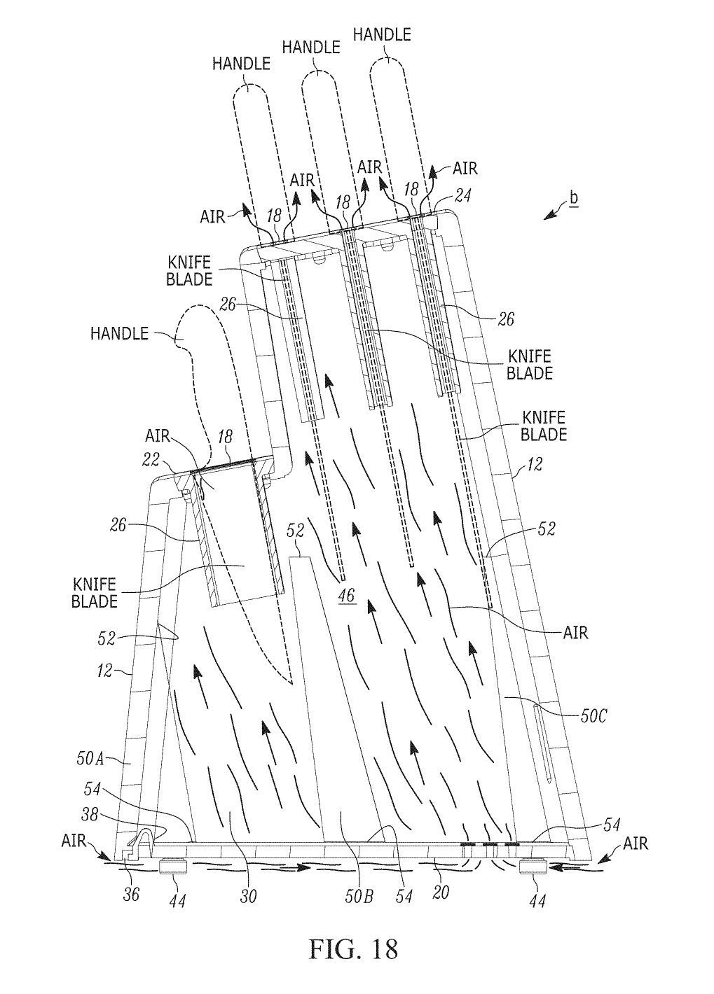

It should be appreciated that an unlimited number of knives of various handle and blades sizes and thicknesses are used with the assembly 10. In the illustrated example embodiment of FIG. 18, the knife blade is approximately one-eighth of one inch or 0.125″ (inches).

The channel guides 26A-26E are sized to: support the blade when stationed in the block 10 so that it will provide ease of insertion and removal; prevent the knives from sitting crooked when nested; maximize air flow about the knife for drying purposes of the knife blade; maximize air flow through the channel when removed from the dishwasher such to dry the channel and prevent rust to the blade; and to minimize the amount of material necessary, thus reducing cost. In the illustrated example embodiment, the upper holding assembly 24 is designed to support or seat generally longer knives, while the lower holding assembly 22 is designed to support or seat relatively shorter knives. For example, the lower holding assembly typically accommodates knives having a blade length of five (5″) inches or less, while the upper holding assembly typically accommodates knives having a blade length of six (6″) to eight (8″) inches or less.

Therefore, in order to achieve many of the advantages by the assembly 10 described above in supporting the various utensils, the channel guides 26A-26E are constructed so that the length or longitudinal extent of the guides in the illustrated example embodiment of FIG. 18 is substantially twice the height or lateral extent of the blade opening 18. For example, the opening 18 for the guides 26A is 0.75″ (inches) lateral extent and 1.5″ (inches) in length or longitudinal extent. In the illustrated example embodiment, unless otherwise indicated, the wall thickness of the block assembly 10 is approximately 0.20″ (inches) throughout.

Referring again to FIGS. 11 and 12, the exploded assembly view of the block 10 illustrates the bottom panel 20. The bottom panel 20 is removably attached to the body 12 of the block 10 to enclose an opening 30. The bottom panel 20 attaches to the body by inserting first and second tabs 32 of the panel into corresponding receiving apertures 34 acting as blind holes and latching a flexible clasp 36 into a notch 38. The panel 20 is removed prior to inserting the block 10 into the dishwasher and allows for the passing of debris, water, and communication of air during the cleaning and drying cycles. The panel 20 is also designed to be placed within the dishwasher for cleaning. Surrounding the perimeter of the opening 30 is a step 40 to act as a peripheral boss to the opening and nest the base plate or panel such that it is flush or recessed with the body 12 of the block 10 as illustrated in the section view of FIG. 18.

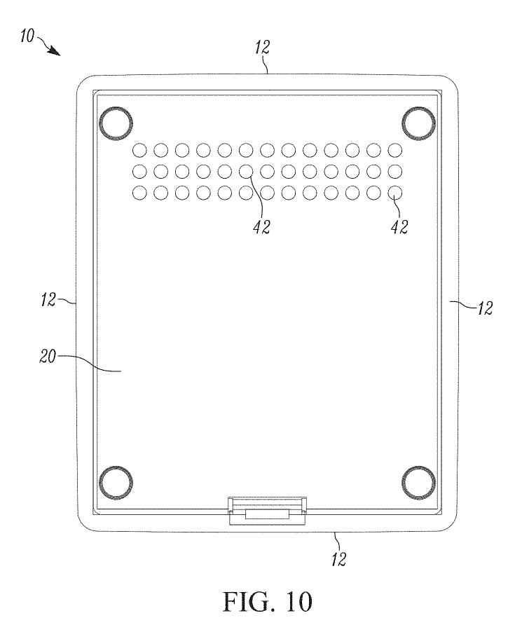

The base plate 20 includes a plurality of openings 42 in a waffle pattern for the passage or communication of air and water when installed as part of the block assembly 10 as illustrated in FIGS. 10 and 18. Each opening in the plurality of openings in the illustrated example embodiment is approximately 0.25″ (inches) in diameter. The base plate 20 further comprises four elastomeric feet 44 that are press-fit or snapped into corresponding holes in the base plate. The feet 44 in the illustrated example embodiment raise the block 10 approximately 0.12″ (inches) from the counter or surface supporting the block, allowing air to flow from under the block and to pass through the openings 42. The feet 44 further prevent sliding movement of the block 10 and potential tipping of the block, which generates a possibly unsafe condition.

The waffle pattern openings are intentionally positioned under the upper holding assembly 24 to provide airflow within a large cavity 46 within the body 12, first or more significantly communicating with/to the longer lives than to the shorter knives in the lower holding assembly 22, as illustrated in FIG. 18. The construct of the block assembly 10 allows when the utensils are in place for air to flow under the block, facilitated by the feet 44 into the waffle openings 42 into the cavity 46, up through the body 12 around the exposed utensils within and through the channels 26A-26E, then out the openings 18. A greater portion of the airflow circulates through channels 26B-26E as illustrated in FIG. 18. This facilitates more air to the longer utensils or knives and provides overall dryness to the channels 26, preventing mildew and reducing the possibility for rust to occur to the utensils.

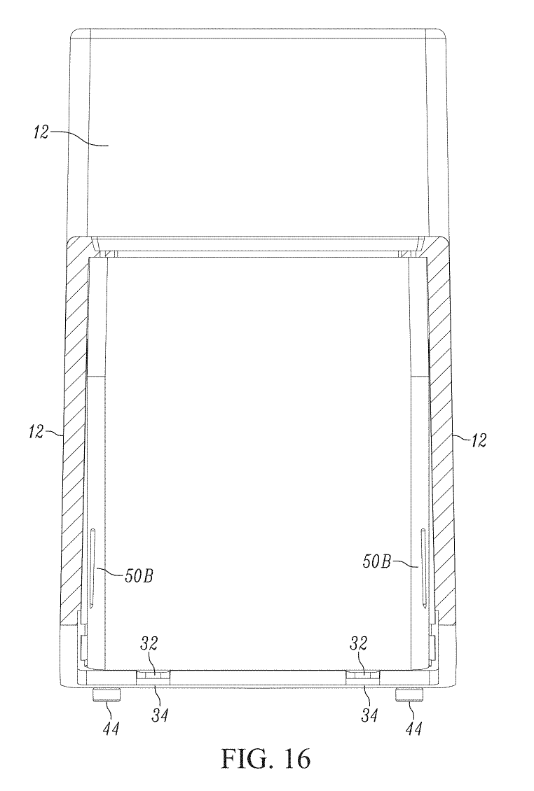

Illustrated in FIGS. 12, 16, and 18 are gussets 50A, 50B, and 50C. The gussets (formed by a build-up of the molded material) are melded into the sidewalls of the body 12 and prevent sink marks or distortion during and after of the molding process of the block 10. The gussets 50 advantageously hold the opening 30 of the cavity 46 to relatively square configuration across all four corners, thus providing the removal and insertion of the panel 20 without issue. In the illustrated example embodiment, the gussets 50 taper from a first end 52 to a second end 54 and are formed in the body 12 mold as part of the body, but with thicker material. The second end 54 assists in forming the step 40, which acts as a stop during insertion of the panel 20.

As can be seen in combination with FIGS, 12, 16, and 18, there are six total gussets 50 in the illustrated example embodiment, comprising an additional thickness to the side walls of the by approximately 0.20″ (inches). Gussets 50A and 50C wrap around the corners 52a and 52c, respectively of the open 30, while gussets 50B are situated substantially centrally about the sidewall of the body 12. The taper of the gussets 50 additionally allow for the holding of the opening 30 shape to a total indicator run-out between opposing walls to an amount less than 0.010″ (inches). The gussets 50 further facilitate the ease of removal or draw from a single mold of the body 12 during forming of the plastic mold injection process of the block 10.

It would be appreciated that the components 20, 12, 22, and 24 are all separately molded. It would further be appreciated that the holding assemblies 22 and 24 could be molded with any number of openings 18 and opening configurations shapes for different utensils and utensils sizes.

Referring again to FIG. 12, and particularly to holding assemblies 22 and 24 each comprise a number of ears 56 that are received in corresponding openings 62 (see FIG. 11) on the lower and upper shelves 58, 60, respectively. Once the desired shape, size, and configuration of the holding assemblies 22 and 24 determined, the holding assemblies, and particularly the ears 56 are glued or heat staked into the openings 62, so that a permanent attachment to the body 12 such that removal cannot occur without destruction of the block 10. Of course, other forms of attachment and fasteners such as screws and corresponding tapped holes are intended to be part of an alternative example embodiment of the present disclosure.

During use, the block 10 has a number of utensils that are used overtime for cutting and preparing food for consumption. After washing the utensils, some debris remains over time on the utensils or the utensils are inadvertently put back into the block 10 without first being washed. At some frequency, the user of the block removes the utensils from the block, removes the panel 20 and inserts the block and its detached panel into a conventional dishwasher. The dishwasher cleans the block 10 and the block can be cleaned with or without a heat dry operation. Once the operation of the dishwasher is complete, the bottom panel 20 is re-attached to the body 12. At such time, the utensils can be reinserted into the block 10. The passage or communication of air as described above and illustrated in FIG. 18 prevents rust, moisture, and mildew from occurring on the utensils or within the knife block assembly 10. The removal of the panel 20 allows for greater access to the channels 26 for cleaning away debris during the washing process, as well allows drying during the heat cycle of a dishwashing machine. The holes 42 continue the passage of air and prevention of rust even aver the panel 20 is reattached to the body 12 and while the utensils are nested in the guides 26.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%. The term “coupled” as used herein is defined as connected or in contact either temporarily or permanently, although not necessarily directly and not necessarily mechanically. A device or structure that is “configured” in a certain way is configured in at least that way, but may also be configured in ways that are not listed.

To the extent that the materials for any of the foregoing embodiments or components thereof are not specified, it is to be appreciated that suitable materials would be known by one of ordinary skill in the art for the intended purposes.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A washable utensil storage assembly comprising;
a body comprising a plurality of walls and at least one shelf for locating a holding assembly for supporting utensils;
the body further comprising a cavity formed by said plurality of walls that is enclosed by said at least one shelf at a first end and a removably positioned panel at a second end spaced from said first end.

2. The washable utensil storage assembly of claim 1 further comprising at least one gusset positioned within said cavity and molded within at least one of said plurality of walls.

3. The washable utensil storage assembly of claim 1 wherein said holding assembly further comprises a plurality of channels for supporting said utensils, said channels each having first and second openings spaced by a longitudinal length, the first opening being planar with the planar surface of said at least one shelf, the channels longitudinal length being greater than the lateral extent of said first opening.

4. The washable utensil storage assembly of claim 1 wherein said at least one shelf further comprises first and second shelves disposed on separate planes and having respective first and second holding assemblies for supporting utensils, said planes being spaced at different distances from said panel.

5. The washable utensil storage assembly of claim 1 wherein said panel further comprises a plurality of vent openings asymmetrically located along and through the surface of said panel, allowing the passage of air from and through said first end to and through said second end.

6. The washable utensil storage assembly of claim 4 wherein said panel further comprises a plurality of vent openings asymmetrically located along and through the surface of said panel, allowing the passage of air through said vent openings of said first end through said cavity and to and through utensil openings at said second end.

7. The washable utensil storage assembly of claim 1 wherein said body is made from a first material and a surface plate of said at least one shelf is made from a second material different from said first material.

8. The washable utensil storage assembly of claim 7 wherein said body is made from a polymeric material and said surface plate of said at least one shelf is made from an antimicrobial polymer.

9. A method of assembling a washable utensil storage assembly, the method comprising the steps of:
molding a body having at least four sides and first and second shelf platforms from a first mold;
molding a first shelf holding assembly from a second mold;
molding a second shelf holding assembly from a third mold;
molding a selectively removable panel from a fourth mold; and
assembling said first shelf holding assembly, said second shelf holding assembly and selectively removable panel to said body.

10. The method of claim 9 further wherein said step of assembling said first shelf holding assembly and said second shelf holding assembly to said body comprises the step of heat staking said the shelf holding assemblies to said body.

11. The method of claim 9 further comprising the step of providing a plurality of vent openings to said selectively removable panel for the passage of air through a cavity formed in said body for drying and anti-oxidation of utensils during storage, the passage continuing through a plurality of utensil openings located in said first and second shelf holding assemblies.

12. The method of claim 11 further comprising the step of positioning said plurality of vent openings in said asymmetrically about said selectively removable panel.

13. The method of claim 11 further comprising the step of providing a plurality of elongated channels having first and second channel openings spaced by a tubular channel body, the first channel openings matching and mating with said plurality of utensil openings in said first and second shelves, the channels continuing into said cavity to said second channel opening.

14. A washable knife block comprising;
a body having a plurality of walls that forms a cavity within the walls, first and second shelves located at a first end of said body, and a selectively removable panel located at a second end of said body, said walls spacing said first end from said second end;
said first and second shelves having respective first and second support members, each support member providing a holding assembly for storing utensils, the holding assembly having a plurality of channels;
said channels having a first opening located on the surface of said shelves and a second opening spaced by a channel body from the first opening, the second opening extending into said cavity; and
a plurality of vent openings asymmetrically located on said selectively removable panel.

15. The washable knife block of claim 14 further comprising at least one gusset positioned within said cavity and molded within at least one of said plurality of walls.

16. The washable utensil storage assembly of claim 14 wherein said body is made from a first material and said surface member is made from a second material different from said first material.

17. The washable knife block of claim 14 wherein said body is made from a polymeric material and said surface members are made from an antimicrobial polymer.

18. The washable knife block of claim 14 wherein said body is formed from a first mold, said selectively removable panel is formed from a second mold, and said first support member is made from a third mold, and said second support member is made from a fourth mold, the first and second support members being heat staked into an opening on respective first and second shelves.

19. The washable knife block of claim 14 wherein said first opening including a lateral length and a width such that said longitudinal length of said channel from said first opening to said second opening is at least twice the amount of said lateral length.

20. The washable knife block of claim 14 wherein said second shelf is further spaced from said selectively removable panel than the distance between the first shelf and selectively removable panel, said vent openings being asymmetrically located with a bias toward said second shelf over said first shelf.
